(19) United States
(12) Patent Application Publication
(10) Pub. No.: US 2011/0202564 A1
(43) Pub. Date: Aug. 18, 2011

(54) Data store switching apparatus, data store switching method, and non-transitory computer readable storage medium

(75) Inventors: Toshihiro Kodaka, Kawasaki (JP); Tomohiro Ohtake, Kawasaki (JP); Yuji Mizobuchi, Kawasaki (JP)

(73) Assignee: Fujitsu Limited, Kawasaki (JP)

(21) Appl. No.: 12/929,764

(22) Filed: Feb. 14, 2011

(30) Foreign Application Priority Data
Feb. 15, 2010 (JP) 2010-030686

(51) Int. Cl. G06F 17/30

(52) U.S. Cl. 707/781; 707/E17.005; 707/E17.044

(57) ABSTRACT

An application characteristic storing unit in a data store switching apparatus stores therein, in an associated manner, characteristic information indicating characteristics of an application and data stores to be accessed by the application. If characteristic information of an application that receives a call request matches the characteristic information of the application stored in the application characteristic storing unit, a method calling unit calls a method that specifies a controller for accessing a data store associated with the characteristic information. The controller specifying unit executes the called method and specifies the controller for accessing the data store associated with the characteristic information. An access control unit controls access from the specified controller to the data store associated with the characteristic information.

### CROSS-REFERENCE TO RELATED APPLICATION

This application is based upon and claims the benefit of priority of the prior Japanese Patent Application No. 2010-030686, filed on Feb. 15, 2010,the entire contents of which are incorporated herein by reference.

### FIELD

The embodiments discussed herein are directed to a data store switching apparatus, a data store switching method, and a non-transitory computer readable storage medium.

### BACKGROUND

In recent years, relational databases (RDB) are used, as data stores for web applications, that manage records in a tabular format in which a plurality of pieces of information is associated with each other. With such RDBs, security is enhanced due to the establishment of the unified access using a structured query language (SQL), the transaction function, and the backup method.

Furthermore, key-value store (KVS) data stores are known as data stores for web applications. Although such KVSs are less powerful than the RDBs in terms of the SQL and transaction functions, larger-scale distribution is available.

When using a system that accumulates data, such as web applications, data is stored, in accordance with the characteristic of an application, in a data store from among a plurality of kinds of data stores. For example, data is stored in the RDB when using an application that only refers to data, whereas data is stored in the KVS when using an application that does not require transactions nor a highly-functional SQL.

Furthermore, because part of data to be stored uses a function unique to RDB, such as transaction, there may be a case in which the data to be stored is divided and a part of the data is stored in the KVS while leaving a part of the data in the RDB. In such a case, by embedding, in a program, a logic that is used to switch data stores and changing the logic of the application, a part of the data is stored in the RDB and another part of the data is stored in the KVS.

Patent Document 1: Japanese Laid-open Patent Publication No. 2002-132568

Patent Document 2: Japanese Laid-open Patent Publication No. 2006-4328

Patent Document 3: Japanese Laid-open Patent Publication No. 09-181723

However, with the method of embedding the logic in order to switch the data stores in the program and changing the logic of the application, there is a problem in that development costs of changing the logic of the application increase and costs of testing the changed application is also increase.

### SUMMARY

According to an aspect of an embodiment of the invention, A data store switching apparatus includes an application characteristic storing unit that stores therein, in an associated manner, characteristic information indicating a characteristic of an application and a data store to be accessed by the application; a method calling unit that calls, if characteristic information of an application that receives a call request matches the characteristic information of the application that is stored in the application characteristic storing unit, a method that specifies a controller for accessing the data store associated with the characteristic information; a controller specifying unit that executes the method called by the method calling unit and specifies the controller for accessing the data store associated with the characteristic information; and an access control unit that controls access from the controller specified by the controller specifying unit to the data store associated with the characteristic information.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating the configuration of a data store switching apparatus according to a first embodiment;

FIG. 2 is a block diagram illustrating the overall configuration of a system including an AP server according to a the second embodiment;

FIG. 3 is a block diagram illustrating the configuration of the AP server according to the second embodiment;

FIG. 4 is a schematic diagram illustrating an example of a data store definition file;

FIG. 5 is a schematic diagram illustrating an example of an application characteristic file and aspect definition information;

FIG. 6 is a schematic diagram illustrating an example of the implementation of a context switching advice;

FIG. 7 is a schematic diagram illustrating an example of a context management definition file;

FIG. 8 is a schematic diagram illustrating an example of an application context definition file for a reference RDB;

FIG. 9 is a schematic diagram illustrating instances managed by a context management mechanism;

FIG. 10 is a schematic diagram illustrating an example of a controller source;

FIG. 11 is a flowchart illustrating the flow of a process performed by the AP server according to the second embodiment; and

FIG. 12 is a flowchart illustrating the flow of a process performed by the AP server according to the second embodiment.

### DESCRIPTION OF EMBODIMENTS

Preferred embodiments of the present invention will be explained with reference to accompanying drawings. The present invention is not limited to the embodiments described below.

### [a] First Embodiment

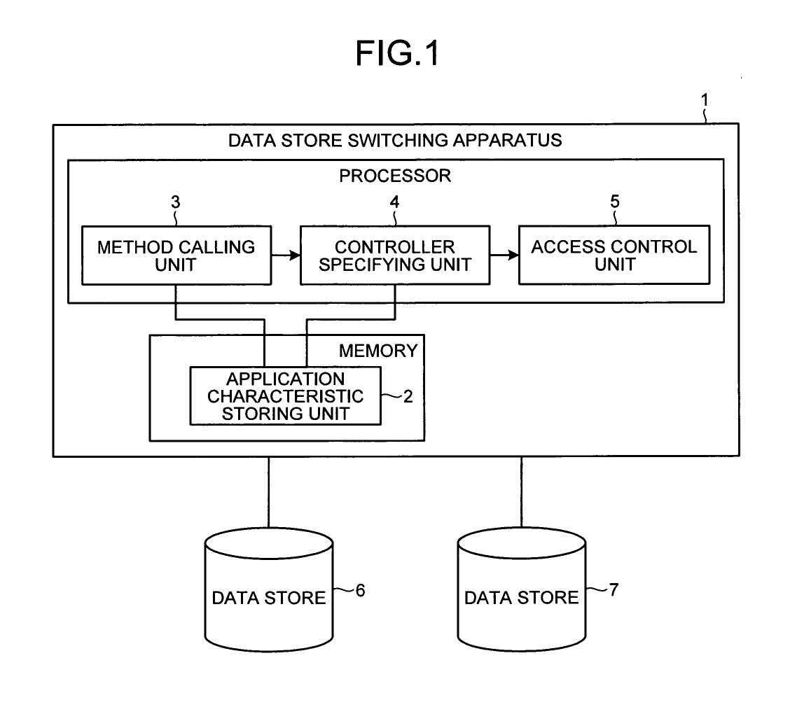

First, the configuration of a data store switching apparatus according to a first embodiment will be described with reference to FIG. 1. FIG. 1 is a block diagram illustrating the configuration of the data store switching apparatus according to the first embodiment.

A data store switching apparatus 1 according to the first embodiment includes an application characteristic storing unit 2, a method calling unit 3, a controller specifying unit 4, and an access control unit 5, which are connected to a plurality of kinds of data stores 6 and 7.

The application characteristic storing unit 2 stores therein, in an associated manner, characteristic information indicating the characteristic of an application and a data store to be accessed by the application. If characteristic information of an application that receives a call request matches the characteristic information of the application that is stored by the application characteristic storing unit 2, the method calling unit 3 calls a method that specifies a controller for accessing the data store associated with the characteristic information.

The controller specifying unit 4 executes the method that is called by the method calling unit 3 and specifies the controller for accessing the data store associated with the characteristic information. The access control unit 5 controls the access from the controller specified by the controller specifying unit 4 to the data store associated with the characteristic information.

In this way, in accordance with the characteristic of the application, the data store switching apparatus 1 automatically change the data store to be accessed. Accordingly, it is possible to quickly change the data stores at low cost without changing the logic of the application.

### [b] Second Embodiment

In the following embodiment, the configuration of the AP server according to a second embodiment will be described first. Then, the flow of a process performed by the AP server and the advantages of the second embodiment will be described in the order they are listed in this sentence. In the second embodiment, a case will be described, as an example, in which an update RDB server, a reference RDB server, and a KVS server are connected to, as data stores, the AP server.

Configuration of the AP Server

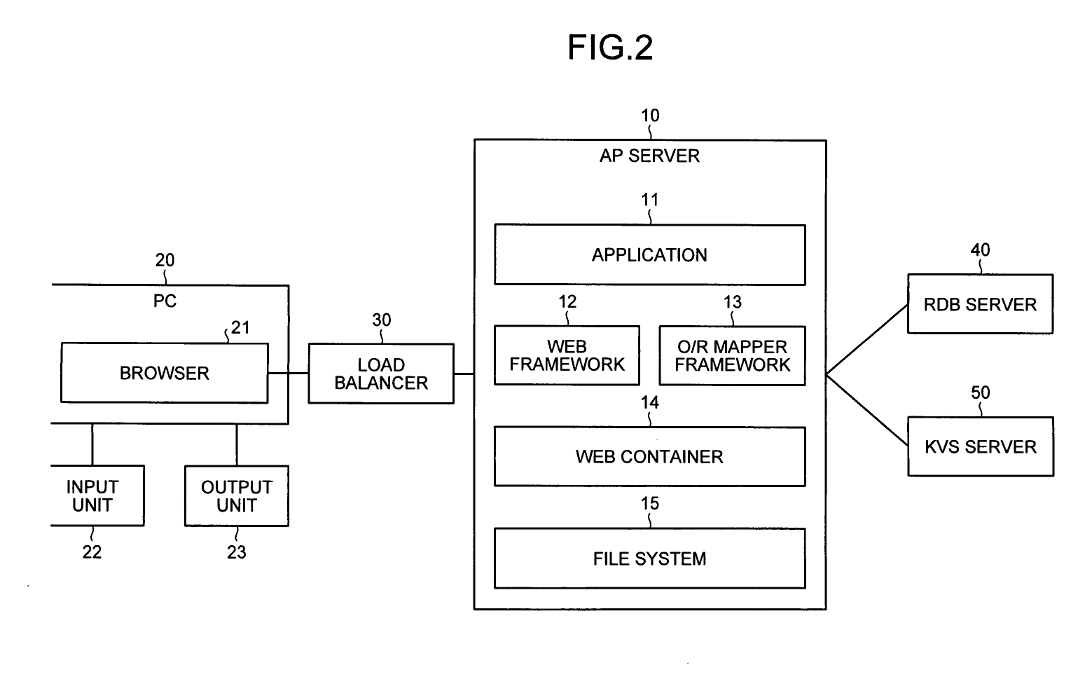

First, the overall configuration of a system including the AP server will be described with reference to FIG. 2. FIG. 2 is a block diagram illustrating the overall configuration of the system including the AP server according to the second embodiment. As illustrated in FIG. 2, the database system includes an application (AP) server 10, a personal computer (PC) 20, a load balancer 30, a relational database (RDB) server 40, and a key-value store (KVS) server 50.

The AP server 10 performs a process in accordance with an HTTP request sent from the PC 20. Specifically, the AP server 10 receives an HTTP request from the PC 20. Then, in order to store or refer data in accordance with the HTTP request, the AP server 10 accesses the data stores, i.e., the RDB server 40 or the KVS server 50.

The AP server 10 includes an application 11 that is a program created by a developer, a Web framework 12 that makes a Web application easy, and an O/R mapper framework 13 that manages data store manage in an integrated manner.

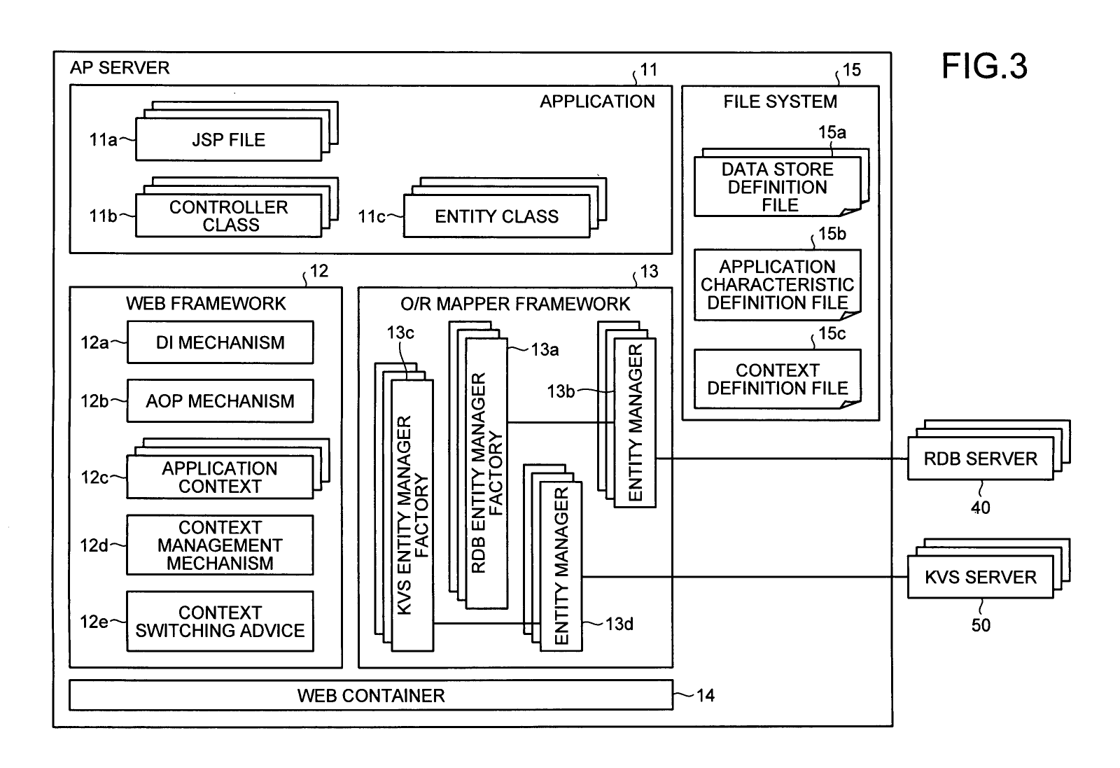

Furthermore, the AP server 10 includes a Web container 14, functioning as a middleware, that calls an associated application in accordance with an HTTP request and that provides a method of accessing a memory, such as session information. The AP server 10 also includes a file system 15 that stores therein various files. A detailed description of the AP server 10 will be given later using FIG. 3.

The PC 20 has an input unit 22, such as a keyboard or a mouse, and an output unit 23, such as a display, and is connected to the load balancer 30 via a network such as the Internet. Furthermore, the PC 20 interacts with a user through an application of a browser 21 and sends an HTTP request to the AP server 10 via the load balancer 30. The load balancer 30 relays the HTTP request received from the PC 20 to the AP server 10.

The RDB server 40 is a data store that manages, in a tabular format, a record in which a plurality of pieces of information is associated and has the update RDB and the reference RDB. The RDB server 40 is partitioned into two, i.e., the update RDB and the reference RDB, and the data stored in the update RDB is periodically copied to the reference RDB. The KVS server 50 is a data store that can perform larger-scale distribution than the RDB server 40 although the KVS server 50 is less powerful than the RDB server 40 in terms of the SQL and transaction functions.

In the following, the configuration of the AP server 10 will be described in detail with reference to FIG. 3. FIG. 3 is a block diagram illustrating the configuration of the AP server according to the second embodiment. The AP server 10 includes the application 11, the Web framework 12, the O/R mapper framework 13, the Web container 14, and the file system 15.

The application 11 is a program created by a developer, which is specified by the Web framework 12 to be developed in accordance with the model view controller (MVC) architecture. The MVC architecture includes, for each application function, a controller (C) for describing business logic, a view (V) that handles a presentation layer, such as the design of a screen, and an entity for determining the format of data to be stored in the data store, each of which includes a plurality of files and classes.

The application 11 includes Java Server Pages (JSP) files 11a (Java is a registered trademark), controller classes 11b, and entity classes 11c. The JSP files 11a each store therein JSP that is a technology for embedding, in HTML pages, calculation results, and codes of Java. The controller classes 11b are classes that are used to control the operation of the Web application. The controller classes 11b are called in accordance with an HTTP request. The entity classes 11c are classes that are used to determine the format of data to be stored in the data store.

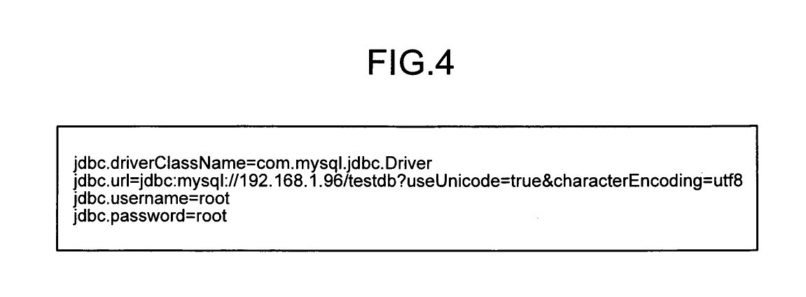

The file system 15 stores therein data store definition files 15a, an application characteristic definition file 15b, and a context definition file 15c. The data store definition files 15a manages URLs for connecting the data store and also manages IDs and passwords for accessing data. Specifically, as illustrated in FIG. 4, in the data store definition files 15a, a “driver”, an “URL”, a “user name”, and a “password” are defined, which are used when the connection is performed using a data store accessing unit, such as the JDBC. Furthermore, a unique name for uniquely determining each data store is added to a file name.

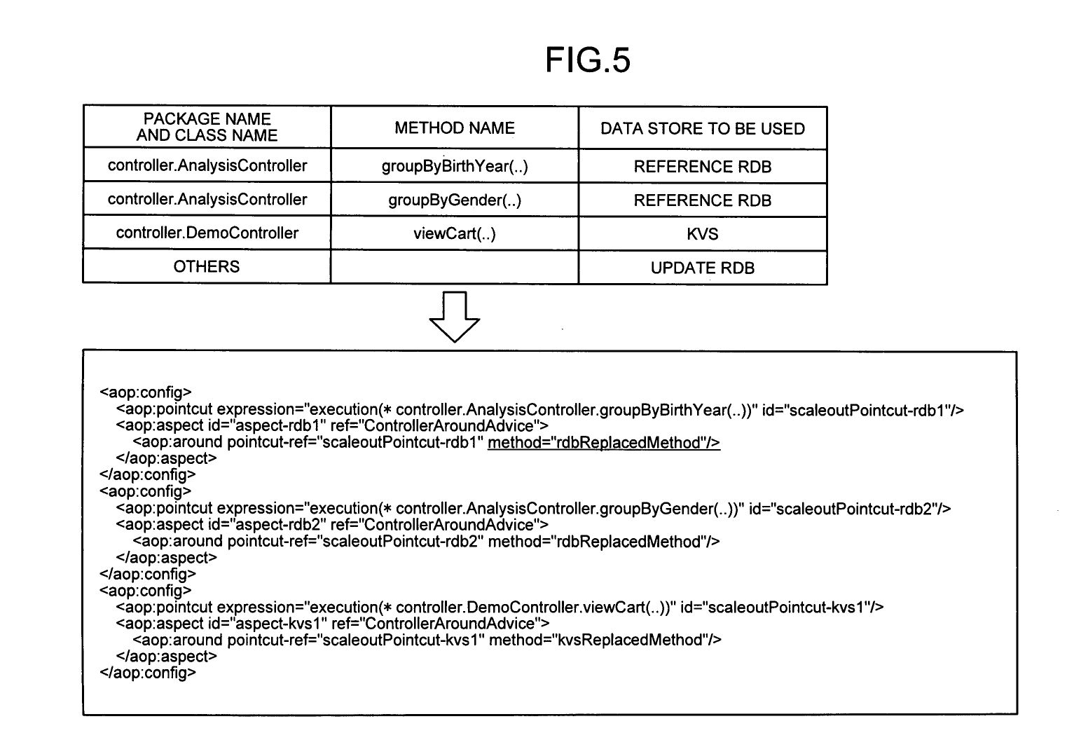

The application characteristic definition file 15b stores therein, in an associated manner, characteristic information indicating the characteristic of an application and a data store to be accessed by the application. The application characteristic definition file 15b describes the access destination of the data store accessed by each method (function) of the controller. Specifically, as illustrated in the upper portion of FIG. 5, the application characteristic definition file 15b stores therein, in an associated manner, a “package name and class name”, a “method name”, and a “data store to be used” that are input by a user in a tabular format, such as a CSV.

The application characteristic definition file 15b is converted into the XML like that illustrated in FIG. 5 before an application is executed. This XML is an aspect definition file that is used in the Spring Framework. It is also possible to directly prepare an aspect definition file in the XML format without creating the application characteristic definition file 15b.

The context definition file 15c defines management information that is used by a context management mechanism 12d to manage a plurality of application contexts. Specifically, a list of application context definitions is described in the context definition file 15c. A definition file group defines an instance (object) that is managed, at runtime, by the context management mechanism 12d.

The Web framework 12 maps an HTTP request onto the controller class 11b that is the actual Java class file and manages the lifecycle, such as the creation or deletion of an instance, of each controller class 11b. The Web framework 12 includes a DI mechanism 12a, an AOP mechanism 12b, a plurality of application contexts 12c, the context management mechanism 12d, and a context switching advice 12e.

The DI mechanism 12a performs lifecycle management, such as the creation or deletion of an instance, and creates an instance in accordance with, for example, a definition file that is separately prepared. The AOP mechanism 12b inserts a program different from the original program or changes logic itself in accordance with the condition, such as a specific method call.

Specifically, if characteristic information of an application that receives a call request matches the characteristic information of the application defined by the aspect definition, the AOP mechanism 12b calls an advice that is a method that specifies a controller for accessing the data store associated with the characteristic information. In AOP, the place in which another program is inserted is referred to as a “join point”, the condition for a change is referred to as a “pointcut”, and a program after the change is referred to as an “advice”.

The plurality of application contexts 12c hold various kinds of information for operating an application and can control the connection between components that are used by the application.

The context management mechanism 12d manages the application contexts 12c. Specifically, the context management mechanism 12d manages the plurality of application contexts 12c for each kind of data store, such as the update RDB, the reference RDB, and the KVS.

For example, the context management mechanism 12d manages a plurality of reference RDB application contexts and KVS application contexts 12c. Then, when the context switching advice 12e changes a call, the context management mechanism 12d selects a single application context from among the plurality of application contexts 12c for reference RDB and for KVS.

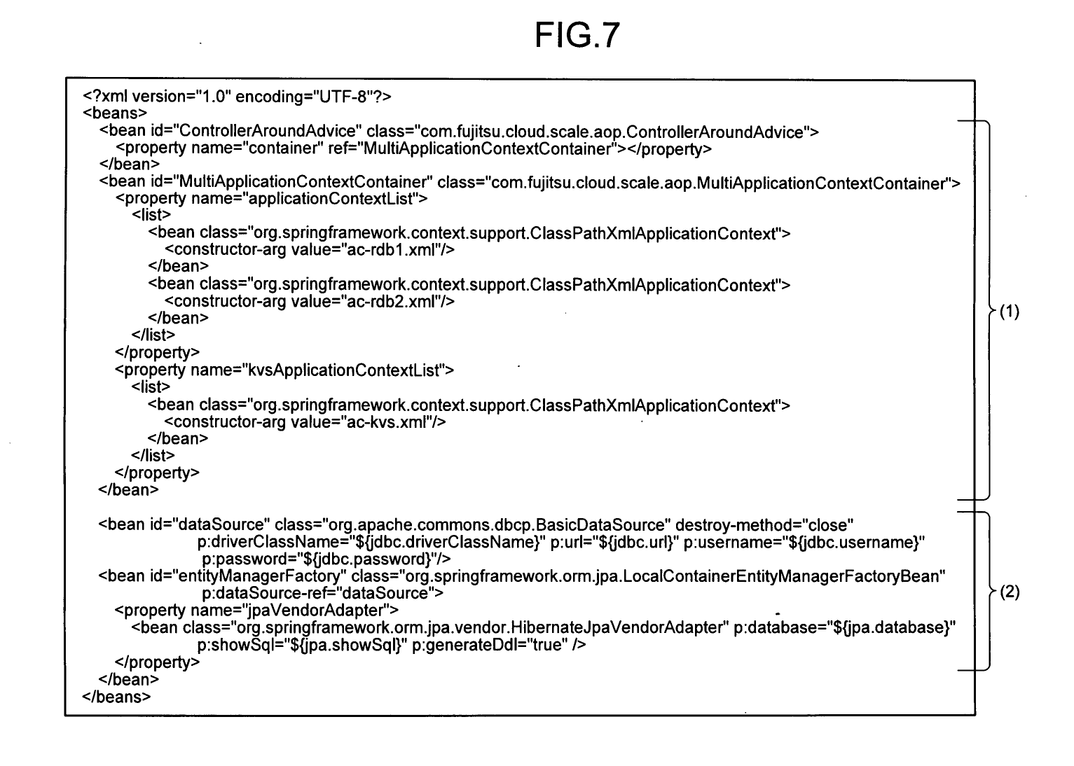

The context management mechanism 12d holds a context management definition file that is a list of the application contexts 12c to be managed. In the following, the context management definition file will be described with reference to FIG. 7. FIG. 7 is a schematic diagram illustrating an example of the context management definition file. The context management definition file illustrated in FIG. 7 is an example obtained when the Spring Framework is used as a Web framework.

As illustrated in FIG. 7, the context management definition file has two parts, i.e., (1) and (2). In part (1), a list of the application context definition for the reference RDB and a list of the application context definition for the KVS are described. In part (2) f the context management definition file, the application context definition for the update RDB is described as the default data store.

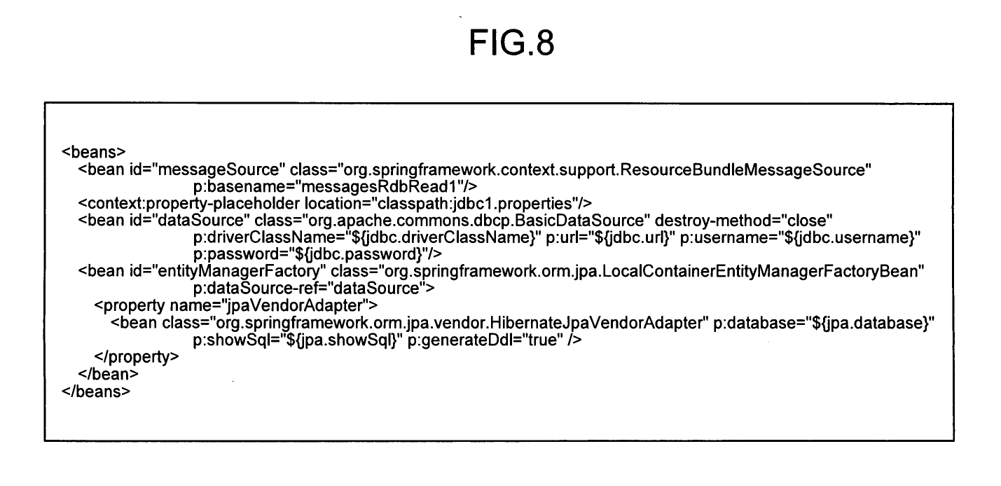

For example, as illustrated in FIG. 8, in the application context definition file for the reference RDB, a list of the application context definition is described. The definition file group is used to define an instance (object) that is managed, at runtime, by the context management mechanism 12d.

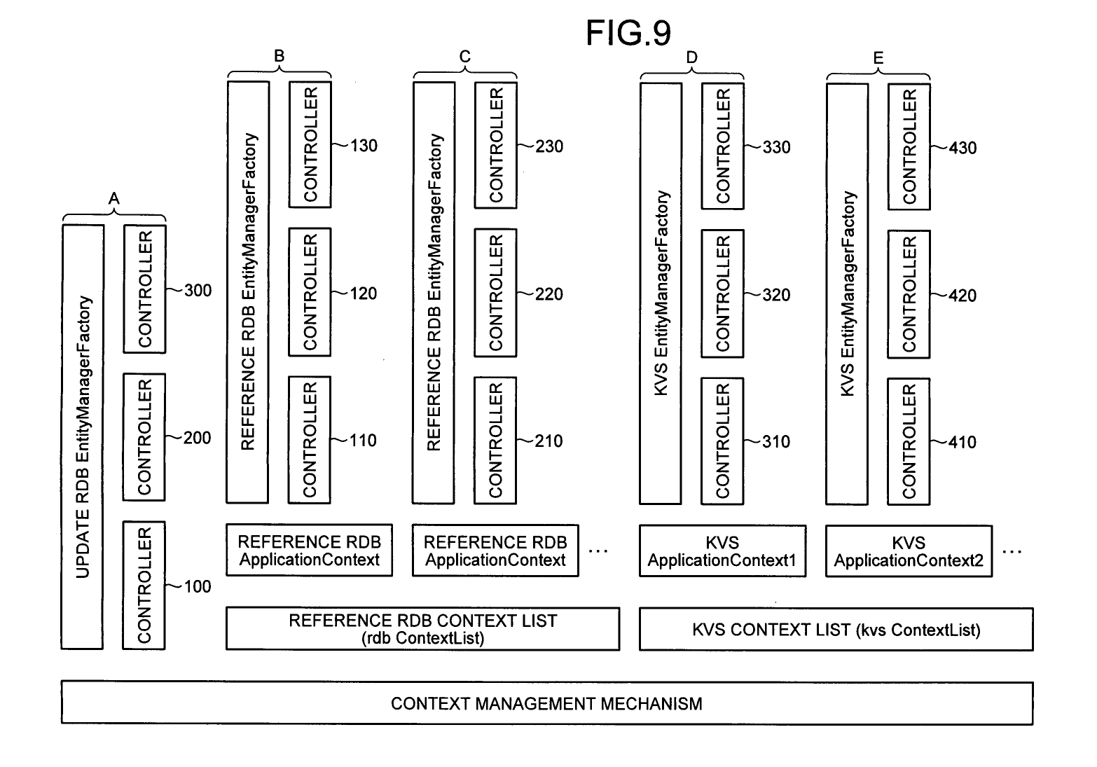

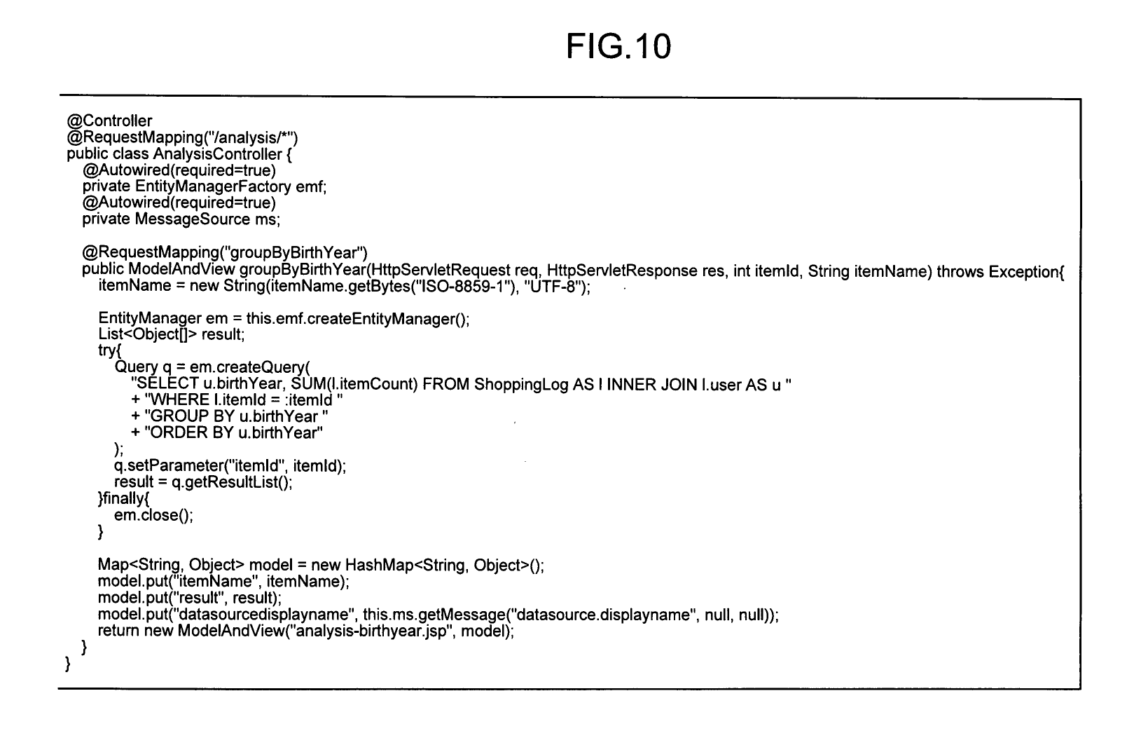

The configuration of the instances at runtime is like that illustrated in FIG. 9. FIG. 9 is a schematic diagram illustrating instances managed by the context management mechanism. The Spring Framework creates the instances at the beginning of the execution. At this time, the Spring Framework creates instances of entity manager factories held by the context management mechanism. If the controller has a source code illustrated in FIG. 10, the Spring Framework substitutes that instance for a field (emf variable in this case) to which “@Autowired” annotation is added (see A of FIG. 9).

Accordingly, controllers 1 to 3 illustrated in A of FIG. 9 can access, using the emf variable, the update RDB entity manager factory that is held by the context management mechanism.

Similarly, a reference RDB context creates instances for the controllers 11 to 13 so as to access from each controller instance to the reference RDB entity manager factory. The same process is also performed on the KVS.

The context switching advice 12e is an advice that is called by the AOP mechanism 12b and is executed in accordance with application characteristic definition. Specifically, the context switching advice 12e holds a method of specifying a controller that is used to access data store associated with characteristic information on an application of a call request. For example, the context switching advice 12e holds an advice method (rdb Replaced Method) for accessing the reference RDB and an advice method (kvs Replaced Method) for accessing the KVS.

In the following, a specific process performed by the Web framework 12 will be described. The Web framework 12 reads, at initial start-up, an aspect definition file illustrated in the lower part of FIG. 5. Then, if there is a call that matches one of a package name, a class name, a method name, and a signature (the type of the argument, the argument list, and the type of the return value) specified by the “expression”, the Web framework 12 changes a call to a method that is an advice specified by a “ref”.

In the example illustrated in the lower part of FIG. 5, the description is “(*controller.AnalysisController.groupByBirthYear(..))”. Specifically, the package name and the class name specified by the “expression” are denoted by “controller.AnalysisController” and the method name is denoted by “groupByBirthYear”. Furthermore, symbol “*” represents a wild card indicating that any type of return value can be used, and symbol “..” indicates that any type and list of argument can be used.

Accordingly, in the example illustrated in FIG. 5, the Web framework 12 detects all of the calls in which the package name is represented by “controller”, the class name is represented by “AnalysisController”, and the method name is represented by “groupByBirthYear”. Then, for all of the detected calls, the Web framework 12 calls a context switching advice that is represented by “rdbReplacedMethod”. At this time, as an argument, the Web framework 12 adds join point information including a package name, a class name, a method name, and a signature of a class that is originally supposed to be executed.

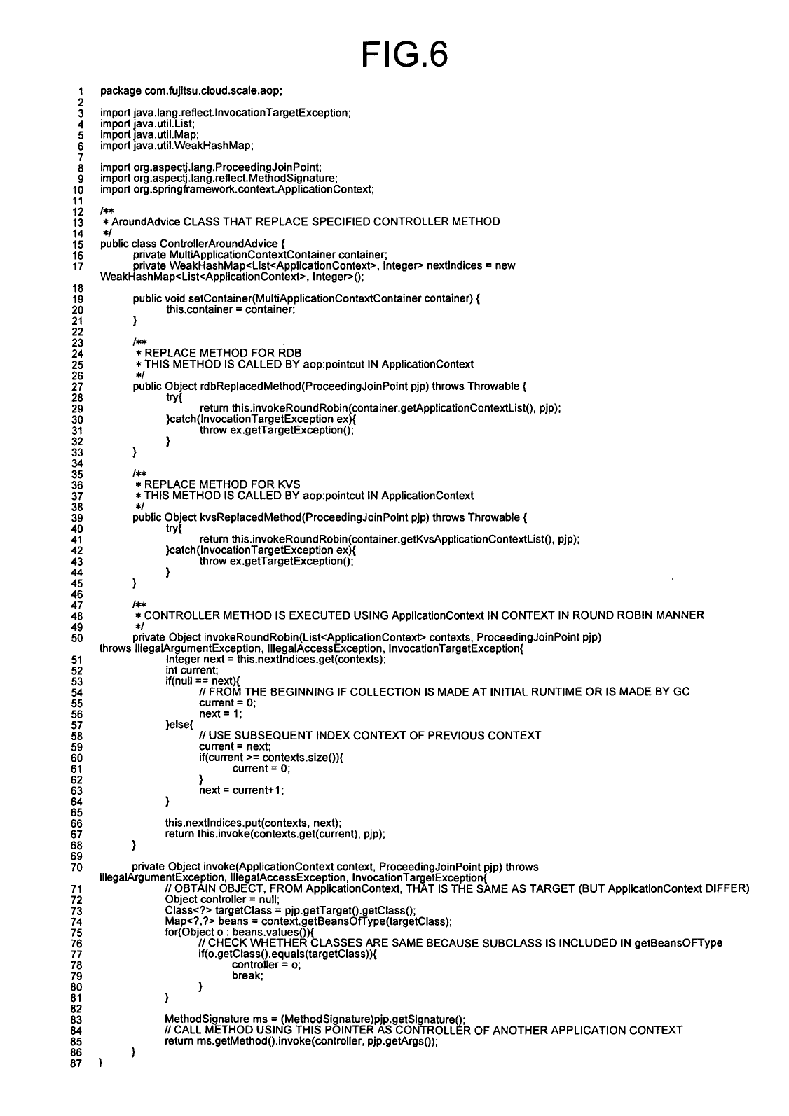

In the following, the context switching advice will be described with reference to FIG. 6. FIG. 6 is a schematic diagram illustrating an example of the implementation of a context switching advice. The Web framework 12 calls, at initial start-up, the method denoted by “setContainer( )” in the 19^{th} line in FIG. 6 and stores an instance of the context management mechanism in a variable container.

The context switching advice 12e holds advice methods for accessing the reference RDB and the KVS (“rdbReplacedMethod” and “kvsReplacedMethod”, respectively). The rdb Replaced Method extracts a reference RDB application context from the list of reference RDB context held by the context management mechanism 12d in a round robin fashion.

Subsequently, the Web framework 12 extracts, from the join point information, information on the package name, the class name, the method name, and the signature of the class that is originally supposed to be executed. Then, the Web framework 12 searches the controller held by the reference RDB application context for a method having the same package name, class name, method name, and signature and then calls that method.

Similarly, for the KVS, the Web framework 12 searches the list of the KVS contexts for a KVS application context in a round robin fashion. Then, the Web framework 12 searches for a controller held by the KVS application context and then calls a method that is originally supposed to be called by the Web framework 12.

In the following, the configuration of the instance that is managed by the context management mechanism 12d will be described. FIG. 9 is a schematic diagram illustrating instances managed by a context management mechanism. The Spring Framework creates an instance of the entity manager factory held by the context management mechanism.

If a controller is the source code illustrated in FIG. 10, the Web framework substitutes that instance for the field (emf variable in this case) to which “@Autowired” annotation is added (see A of FIG. 9). Accordingly, the controllers 1 to 3 illustrated in A of FIG. 9 can access, using the emf variable, the update RDB entity manager factory that is held by the context management mechanism.

Similarly, the reference RDB context creates instances for the controllers 110 to 130 so as to access from each controller instance to the reference RDB entity manager factory. The same process is also performed on the KVS.

In other words, the context switching advice 12e calls the “rdbReplacedMethod” as described above. Then, the context switching advice 12e extracts one reference RDB application context in a round robin fashion and calls, from the extracted reference RDB application context, a controller instance in the same class that is originally supposed to be executed. Accordingly, in the example illustrated in FIG. 9, if a call is performed using the controller 1, the call is performed using the controller 110 (or a controller 210).

The controllers 100 and 110 are in the same class but have different Entity Manager Factory. Because the Entity Manager Factory held by the controller 110 is for the reference RDB, if access is performed through this Entity Manager Factory, information, such as the actual RDB URL or a driver, is extracted by referring to a data store definition file, and data is obtained from the reference RDB.

It is also applied to a case in which the KVS is used. With the KVS, a method denoted by “kvsReplacedMethodmethod” is called as an advice to be called. In a similar manner as in the RDB, this method selects, from the list of the KVS contexts, one KVS application context that is used in a round robin fashion; selects, from the controller held by that context, a method having the same name as the method that is originally supposed to be executed by an application. Accordingly, because the entity manager factory held by the controller becomes the KVS entity manager factory, it is possible to change the data store to be accessed from the update RDB to the KVS. In this way, the data store to be accessed can be changed from the update RDB to the reference RDB or to the KVS without changing the code itself of the application.

In the following, a case in which the update RDB is used without processing anything will be described. In AOP, the update RDB is used if a rule that is used for AOP to change a method is not described. When the AOP mechanism weaves an aspect at runtime, because a pointcut with respect to the execution of a method corresponding to the aspect definition illustrated in FIG. 5 is not described, method conversion is not performed and thus the controllers 1 to 3 obtained by the context management mechanism are called. In the controllers, an instance of the update RDB entity manager factory for is injected by the DI mechanism. Accordingly, the update RDB entity manager factory is used, which makes it possible to access the update RDB.

The O/R mapper framework 13 perpetually stores, in the relational database or the KVS, an object in an object oriented language, such as Java. For example, the Java Persistence API (JPA) is one example as O/R mapper framework standardized by JSR.

The O/R mapper framework 13 includes entity managers (EntityManager) 13b and 13d as a library that is used to access the actual data store. Furthermore, the O/R mapper framework 13 also includes entity manager factories (EntityManagerFactory) 13a and 13c as a library that is used to create instances of the entity managers.

The entity manager factories 13a and 13c and the entity managers 13b and 13d are prepared for each data store that is used. In the O/R mapper framework 13, the number of entity manager factories 13a and 13c prepared corresponds to that of the data stores to be used.

The RDB entity manager factories 13a are referred to as factory classes and have a function of simultaneously creating a plurality of entity manager objects that can be connected to the RDB. Accordingly, if a lot of requests are received at the same time, the entity managers operate and create objects, thus maintaining the performance.

Similarly, the KVS entity manager factories 13c each have a function of simultaneously creating a plurality of entity manager objects that can be connected to the KVS. Accordingly, if a lot of requests are received at the same time, the entity managers operate and create, thus maintaining the performance.

The entity managers 13b are libraries for accessing the RDB server 40. The entity managers 13d are libraries for accessing the KVS server 50.

The Web container 14 is a middleware that calls an application associated with a request from the HTTP and provides a method of accessing a memory, such as session information. The Web container 14 recognizes the Web framework 12 as an application.

Examples of the Web container 14 include Interstage Application Server, Apache Tomcat, and open source product. Furthermore, in the AP server 10, in addition to the Web container 14, the Web framework 12 that is used to facilitate the development of the Web application and the O/R mapper framework 13 that manages the connection to the data store in an integrated manner are used as a framework group for facilitating the development.

Process Performed by the AP Server

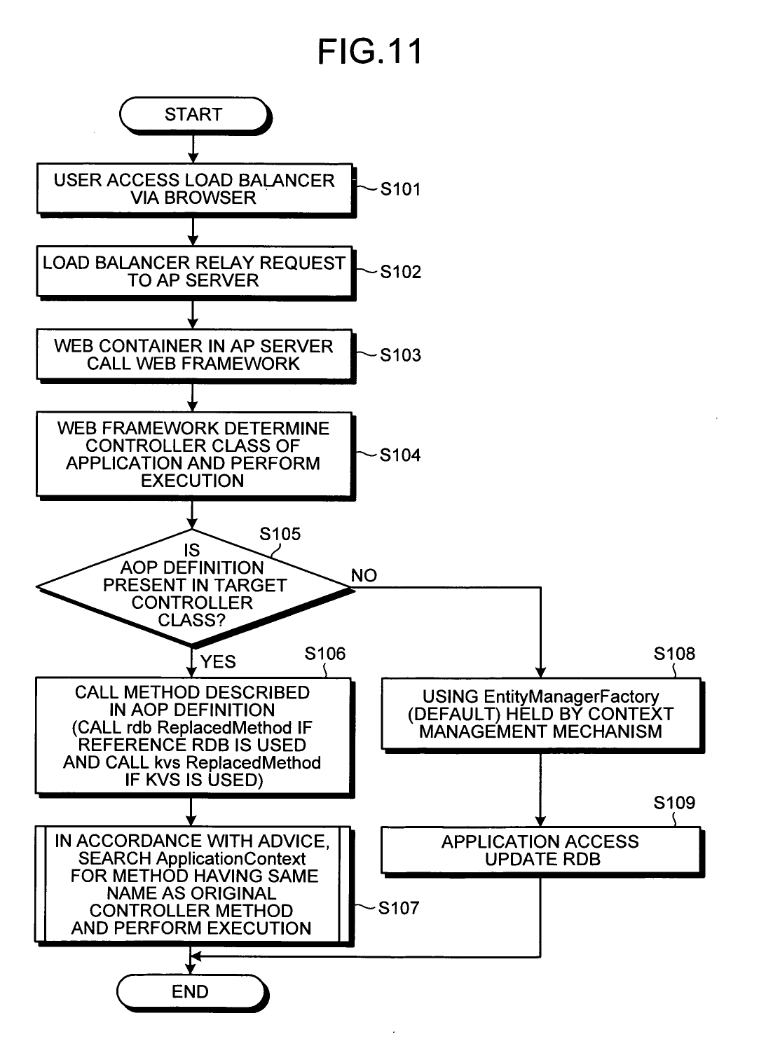

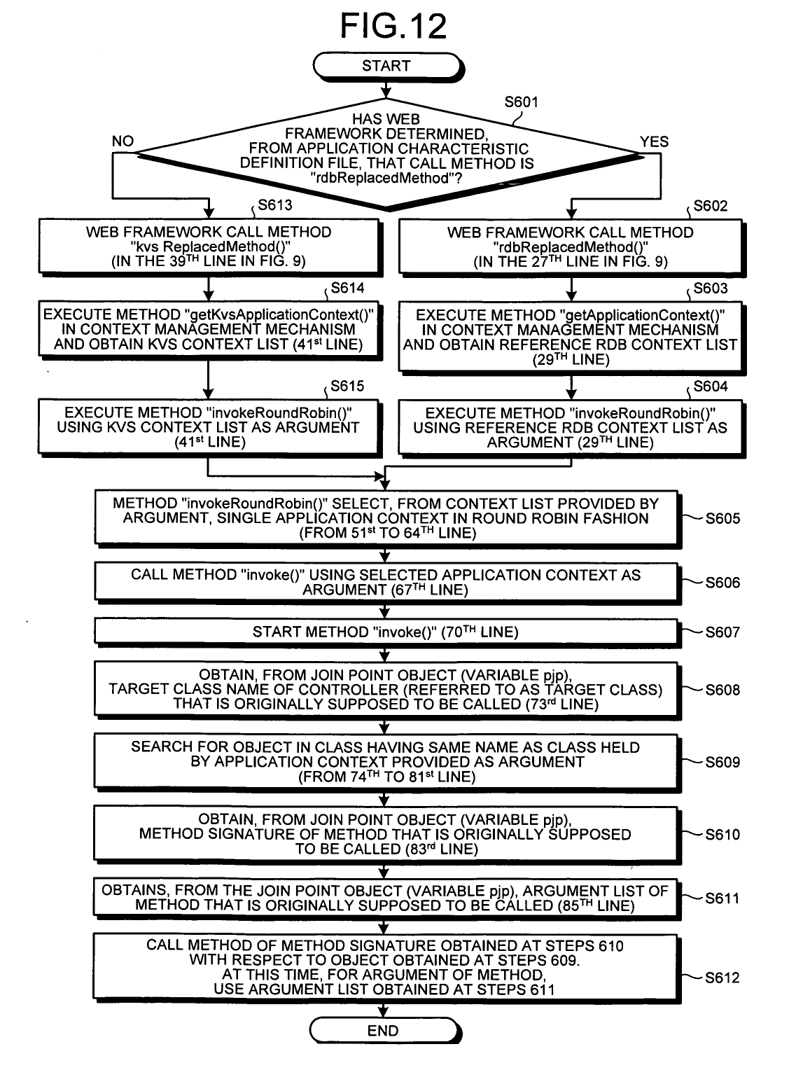

In the following, a process performed by the AP server 10 according to the second embodiment will be described with reference to FIG. 3. FIGS. 11 and 12 are flowcharts illustrating the flow of processes performed by the AP server according to the second embodiment.

As illustrated in FIG. 11, if a user accesses the load balancer 30 via a browser (Step S101), the load balancer 30 relays a request to the AP server 10 whose load is low (Step S102). For example, if a user operates a browser to access “http://foo.com/analysis/groupByBirthYear”, the load balancer 30 receives the request and relays the request to the AP server 10.

Then, the Web container 14 in the AP server 10 calls a Web framework (Step S103). For example, the Web container running in the AP server calls a Web framework in accordance with a Web definition file, for example, “web.xml file” in the Java Servlet specification (not illustrated).

Then, the Web framework 12 in the AP server 10 determines a controller class of an application and performs the execution (Step S104). Specifically, the Web framework 12 determines an application to be called in accordance with an URL. For example, because a first path name of the URL is “analysis” and a second parameter is “groupByBirthYear”, a method denoted by “groupByBirthYear” in a controller class is determined in accordance with the rule of Spring Framework, (see FIG. 10). At this time, the class executed by the Spring Framework falls on any one of the default controllers 1 to 3 managed by the context management mechanism 12d.

Subsequently, the AP server 10 determines whether a target aspect definition is present in the controller class to be executed (Step S105). As a result, if an AOP definition is present in the specified controller class (Yes at Step S105), the AP server 10 calls a method described in the aspect definition (Step S106).

For example, the AOP mechanism 12b in the AP server 10 converts, in accordance with the aspect definition illustrated in the lower part of FIG. 5, a method to an advice (in the example illustrated in FIG. 5, converts to the method denoted by “rdbReplacedMethod” that is an advice). Then, the Web framework 12 in the AP server 10 executes the method denoted by “rdbReplacedMethod” and adds, as an argument, join point information including information, such as a package name, a class name, a method name, and a signature (an argument, a return value, etc.) of a class that is originally supposed to be executed.

Then, in accordance with the advice, the AP server 10 searches the application context for a method having the same name as the original controller method and performs the execution (Step S107) (a description will be given in detail later with reference to FIG. 12).

Furthermore, if the AOP definition is not present in the controller class to be executed (No at Step S105), by using the default entity manager factory held by the context management mechanism 12d (Step S108), the application 11 in the AP server 10 accesses the update RDB (Step S109).

In the following, a process will be described in detail with reference to FIG. 12, in which a method having the same name as the original controller method is searched for an application context in accordance with an advice. In the following description, the context switching advice illustrated in FIG. 6 is used as an example.

As illustrated in FIG. 12, if the Web framework 12 in the AP server 10 determines that, from the application characteristic definition file, a call method is “rdbReplacedMethod” (Yes at Step S601), the Web framework 12 calls a method denoted by “rdbReplacedMethod( )” (see in the 27^{th} line in FIG. 6) (Step S602).

Then, the AP server 10 executes a method denoted by “getApplicationContext( )” in the context management mechanism 12d and obtains the reference RDB context list (see in the 29^{th} line in FIG. 6) (Step S603). Subsequently, the AP server 10 executes a method denoted by “invokeRoundRobin( )” using the reference RDB context list as an argument (see in the 29^{th} line in FIG. 6) (Step S604).

Furthermore, if the Web framework 12 in the AP server 10 determines that, from the application characteristic definition file, a call method is “kvsReplacedMethod” (No at Step S601), the Web framework 12 calls a method denoted by “kvsReplacedMethod( )” (see in the 39^{th} line in FIG. 6) (Step S613).

Then, the AP server 10 executes a method denoted by “getKvsApplicationContext( )” in the context management mechanism 12d and obtains the KVS context list (see in the 41^{st} line in FIG. 6) (Step S614). Subsequently, the AP server 10 executes a method denoted by “invokeRoundRobin( )” using the KVS context list as an argument (see in the 41^{st} line in FIG. 6) (Step S615).

Then, in the AP server 10, the method denoted by “invokeRoundRobin( )” selects, from the context list provided by the argument, a single application context in a round robin fashion (see in the 51^{st} to 64^{th} line in FIG. 6) (Step S605). The AP server 10 calls a method denoted by “invoke( )” using the selected application context as an argument (see in the 67^{th} line in FIG. 6) (Step S606).

Then, the AP server 10 executes the method denoted by “invoke( )” (see in the 70^{th} line in FIG. 6) (Step S607) and obtains a target class name of the controller that is originally supposed to be called from the join point object (see in the 73^{rd} line in FIG. 6) (Step S608).

The AP server 10 searches for an object in a class having the same name as the class held by the application context provided as an argument (see in the 74^{th} to 81^{st} lines in FIG. 6) (Step S609). Subsequently, the AP server 10 obtains, from the join point object (variable pjp), a method signature of the method that is originally supposed to be called (see in the 83^{rd} line in FIG. 6) (Step S610).

Then, the AP server 10 obtains, from the join point object (variable pjp), an argument list of the method that is originally supposed to be called (see in the 85^{th} line in FIG. 6) (Step S611). Thereafter, the AP server 10 calls a method of the obtained method signature with respect to the searched object. At this time, for the argument of the method, the AP server 10 uses the argument list obtained at Step S611 (see in the 85^{th} line in FIG. 6) (Step S612).

Advantage of the Second Embodiment

As described above, the AP server 10 holds the application characteristic definition file 15b that stores therein, in an associated manner, characteristic information indicating the characteristic of an application and a data store to be accessed by the application. Then, if characteristic information of an application that receives a call request matches the characteristic information of the application that is stored in the application characteristic definition file 15b, the AP server 10 calls a method that specifies a controller for accessing the data store associated with the characteristic information. Subsequently, the AP server 10 executes the called method and specifies the controller for accessing the data store associated with the characteristic information. Then, the AP server 10 controls the access from the specified controller to the data store associated with the characteristic information.

Accordingly, because the AP server 10 can automatically change the data store to be accessed in accordance with the characteristic information of the application, it is possible to quickly change data stores at low cost without changing the logic of the application.

Furthermore, according to the second embodiment, if characteristic information of an application that receives a call request matches the characteristic information of the application stored in the application characteristic definition file 15b, from among the plurality of the controllers for accessing the data stores associated with the characteristic information, the AP server 10 calls a method that specifies a controller in the same controller class associated with the application that receives the call request. Accordingly, the data store to be accessed can be appropriately changed.

Furthermore, according to the second embodiment, because the application characteristic definition file 15b stores therein, as characteristic information, a package name, a class name, a method name, the type of argument, and the type of return value, data stores can be switched in accordance with the characteristic of an application.

Furthermore, according to the second embodiment, the application characteristic definition file 15b in the AP server 10 stores therein a reference relation database or a key value store as a data store to be accessed. Accordingly, for an application that only refers to data, the loads can be distributed to a plurality of reference RDBs, thus improving the performance at the time of mass access. Furthermore, for an application that does not require a transaction nor a high-performance SQL, the loads can be distributed to multiple KVSs, thus improving the performance at the time of mass access including an update.

### [c] Third Embodiment

In the above explanation, the embodiment of the present invention has been described; however, the present invention can be implemented with various kinds of embodiments other than the embodiment described above. Therefore, another embodiment included in the present invention will be described below as a third embodiment.

(1) System Configuration, etc.

The components of each device illustrated in the drawings are only for conceptually illustrating the functions thereof and are not necessarily physically configured as illustrated in the drawings. In other words, the specific shape of a separate or integrated device is not limited to the drawings; however, all or part of the device can be configured by functionally or physically separating or integrating any of the units depending on various loads or use conditions. For example, the RDB entity manager factories 13a and the entity managers 13b can be integrated. Furthermore, all or any part of the processing functions performed by each device can be implemented by a CPU and by programs analyzed and executed by the CPU or implemented as hardware by wired logic.

(2) Programs

The data store switching method described in the embodiments can be implemented by a program prepared in advance and executed by a computer such as a personal computer or a workstation. The program can be sent using a network such as the Internet. Furthermore, the program can be stored in a computer-readable recording medium, such as a hard disc drive, a flexible disk (FD), a CD-ROM, an MO, and a DVD. The computer can then read and execute the program from the above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data store switching apparatus comprising:
an application characteristic storing unit that stores therein, in an associated manner, characteristic information indicating a characteristic of an application and a data store to be accessed by the application;
a method calling unit that calls, if characteristic information of an application that receives a call request matches the characteristic information of the application that is stored in the application characteristic storing unit, a method that specifies a controller for accessing the data store associated with the characteristic information;
a controller specifying unit that executes the method called by the method calling unit and specifies the controller for accessing the data store associated with the characteristic information; and
an access control unit that controls access from the controller specified by the controller specifying unit to the data store associated with the characteristic information.

2. The data store switching apparatus according to claim 1, wherein, if characteristic information of the application that receives the call request matches the characteristic information of the application that is stored in the application characteristic storing unit, the method calling unit calls, from among a plurality of controllers for accessing the data store associated with the characteristic information, a method that specifies a controller in the same class as that associated with the application that receives the call request.

3. The data store switching apparatus according to claim 1, wherein the application characteristic storing unit stores therein, as characteristic information, a package name, a class name, a method name, the type of an argument, and the type of a return value.

4. The data store switching apparatus according to claim 2, wherein the application characteristic storing unit stores therein, as characteristic information, a package name, a class name, a method name, the type of an argument, and the type of a return value.

5. The data store switching apparatus according to claim 1, wherein the application characteristic storing unit stores therein, as a data store to be accessed, a reference relation database or a key value store.

6. The data store switching apparatus according to claim 2, wherein the application characteristic storing unit stores therein, as a data store to be accessed, a reference relation database or a key value store.

7. The data store switching apparatus according to claim 3, wherein the application characteristic storing unit stores therein, as a data store to be accessed, a reference relation database or a key value store.

8. A data store switching apparatus including:
a processor; and
a memory storing therein, in an associated manner, a characteristic information indicating a characteristic of an application and a data store to be accessed by the application, wherein the processor executes:
calling, if a characteristic information of an application that receives a call request matches the characteristic information of the application that is stored in the memory, a method that specifies a controller for accessing the data store associated with the characteristic information;
executing the method called and specifies the controller for accessing the data store associated with the characteristic information and;
controlling access from the controller specified to the data store associated with the characteristic information.

9. A data store switching method, comprising:
calling, if characteristic information of an application that receives a call request matches characteristic information of an application that is stored in a application characteristic storing unit, a method that specifies a controller for accessing the data store associated with the characteristic information, the application characteristic storing unit storing therein, in an associated manner, the characteristic information indicating a characteristic of the application and the data store to be accessed by the application;
executing the method called and specifies the controller for accessing the data store associated with the characteristic information and; controlling access from the controller specified to the data store associated with the characteristic information.

10. A non-transitory computer readable storage medium having stored therein a data store switching program causing a computer to execute a process comprising:
calling, if characteristic information of an application that receives a call request matches characteristic information of an application that is stored in a application characteristic storing unit, a method that specifies a controller for accessing the data store associated with the characteristic information, the application characteristic storing unit storing therein, in an associated manner, the characteristic information indicating a characteristic of the application and the data store to be accessed by the application;
executing the method called and specifies the controller for accessing the data store associated with the characteristic information and; controlling access from the controller specified to the data store associated with the characteristic information.
